(19) United States
(12) Patent Application Publication
(10) Pub. No.: US 2022/0074743 A1
(43) Pub. Date: Mar. 10, 2022

(54) AERIAL SURVEY METHOD, AIRCRAFT, AND STORAGE MEDIUM

(71) Applicant: SZ DJI TECHNOLOGY CO., LTD., Shenzhen (CN)

(72) Inventors: Zhenhao HUANG, Shenzhen (CN); Jianlin CHEN, Shenzhen (CN); Fu XU, Shenzhen (CN)

(21) Appl. No.: 17/529,000

(22) Filed: Nov. 17, 2021

Related U.S. Application Data
(63) Continuation of application No. PCT/CN2019/088321, filed on May 24, 2019.

(51) Int. Cl. G01C 15/00; G05D 1/10; G05D 1/00; B64D 47/08; B64C 39/02

(52) U.S. Cl. CPC G01C 15/008; G05D 1/101; B64C 2201/127; B64D 47/08; B64C 39/024; G05D 1/0094

(57) ABSTRACT

An aerial survey method includes controlling a photographing device of an aircraft to shoot an orthophoto, obtaining flight information corresponding to the orthophoto, determining a flight altitude, a flight radius, and a circumnavigation center of the aircraft in oblique shooting according to the flight information, and controlling flight of the aircraft and an orientation of the photographing device according to the flight altitude, the flight radius, and the circumnavigation center to shoot an oblique photo.

### CROSS-REFERENCE TO RELATED APPLICATION

This application is a continuation of International Application No. PCT/CN2019/088321, filed May 24, 2019, the entire content of which is incorporated herein by reference.

### TECHNICAL FIELD

The present disclosure relates to the technical field of aerial survey and, more particularly, to an aerial survey method, an aircraft, and a storage medium.

### BACKGROUND

Currently, in field of unmanned aerial vehicle surveying and mapping applications, the most widely used application is orthophoto shooting, which is used for reconstruction of a digital orthophoto map (DOM)/a digital elevation model (DEM). However, with cost reduction, miniaturization, intelligence, and civilianization of unmanned aerial vehicles, costs of the unmanned aerial vehicles and equipped cameras are further reduced. Even if quasi-professional or even consumer-grade cameras and lenses are used, most internal parameters of the camera have not been rigorously calibrated, and when an image of an orthophoto is directly used for mapping at this time, there will be a system deviation in elevation. In conventional aerial survey methods, final mapping accuracy is ensured through marking a large number of ground control points, but operation process thereof is time-consuming, labor-consuming, and costly. Therefore, it is needed to provide an aerial survey method to solve the above problems.

### SUMMARY

In accordance with the disclosure, there is provided an aerial survey method including controlling a photographing device of an aircraft to shoot an orthophoto, obtaining flight information corresponding to the orthophoto, determining a flight altitude, a flight radius, and a circumnavigation center of the aircraft in oblique shooting according to the flight information, and controlling flight of the aircraft and an orientation of the photographing device according to the flight altitude, the flight radius, and the circumnavigation center to shoot an oblique photo.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 is a schematic flow chart of an aerial survey method according to an embodiment of the present disclosure.

FIG. 2 is a schematic diagram showing an effect of determining a flight area according to an embodiment of the present disclosure.

FIGS. 3A-3C are schematic diagrams showing an effect of determining a circumnavigation center according to an embodiment of the present disclosure.

FIGS. 4A and 4B are schematic diagrams showing an effect of determining a circumnavigation route according to an embodiment of the present disclosure.

FIG. 5 is a schematic flow chart of another aerial survey method according to an embodiment of the present disclosure.

FIG. 6 is a schematic flow chart of sub-processes of the aerial survey method in FIG. 5.

FIG. 7 is a schematic flow chart of another aerial survey method according to an embodiment of the present disclosure.

FIG. 8 is a schematic flow chart of another aerial survey method according to an embodiment of the present disclosure.

FIG. 9 is a schematic flow chart of sub-processes of the aerial survey method in FIG. 8.

FIG. 10 is a schematic structural block diagram of an aircraft according to an embodiment of the present disclosure.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

The flow charts shown in the drawings are only examples, and do not necessarily include all contents and operations/processes, nor does it have to be executed in the described order. For example, some operations/processes can also be decomposed, combined or partially combined, so the actual execution order may be changed depending on actual conditions.

Some embodiments of the present disclosure will be described in detail with reference to the accompanying drawings. In the case of no conflict, the following embodiments and features in the embodiments can be combined with each other.

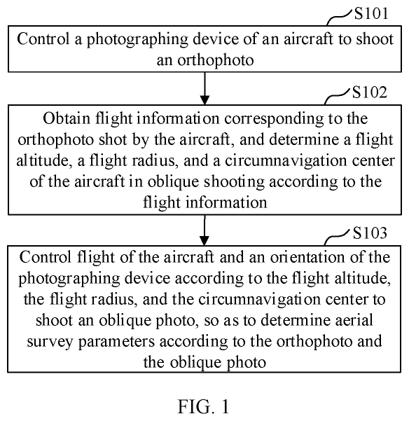

FIG. 1 is a schematic flow chart of an aerial survey method according to an embodiment of the present disclosure. The aerial survey method can be applied to an aircraft. The aircraft includes an unmanned aerial vehicle, and the unmanned aerial vehicle is provided with a photographing device. The photographing device includes a camera, or a camera and a gimbal configured to mount the camera. The camera can be a quasi-professional camera, a consumer-grade camera, a camera using a consumer-grade lens, or even a camera with internal parameters that have not been precisely calibrated, such as a focal length.

The unmanned aerial vehicle can be a rotor unmanned aerial vehicle, such as a four-rotor unmanned aerial vehicle, a six-rotor unmanned aerial vehicle, or an eight-rotor unmanned aerial vehicle, or can be a fixed-wing unmanned aerial vehicle.

In some embodiments, as shown in FIG. 1, the aerial survey method includes processes S101-S103.

S101, controlling the photographing device of the aircraft to shoot an orthophoto.

The aircraft is used to perform aerial survey shooting, and the photographing device of the aircraft is controlled to shoot the orthophoto. As used in this disclosure, “photo” can refer to an image collection containing one or more images. For example, an orthophoto can be an image collection containing one or more orthoimages. The aircraft can fly according to pre-set flight parameters during the aerial survey shooting, and the photographing device is controlled to shoot the orthophoto during flight of the aircraft. The flight parameters include, but are not limited to, a preset flight route, aerial survey altitude, and flight speed. The aerial survey altitude is a flight altitude set during aerial survey of the aircraft.

After the photographing device of the aircraft is controlled to complete shooting the orthophoto, the orthophoto is saved or sent to a ground control terminal. Video transmission technology can also be used to transmit the shot orthophoto to the ground control terminal in real time. While the orthophoto is shot, flight information corresponding to the orthophoto shot by the aircraft is recorded. The flight information includes flight route information, the aerial survey altitude, the flight speed, camera parameters, etc.

S102, obtaining the flight information corresponding to the orthophoto shot by the aircraft, and determining the flight altitude, the flight radius, and the circumnavigation center of the aircraft in oblique shooting according to the flight information.

After the photographing device of the aircraft is controlled to complete shooting the orthophoto, the flight information corresponding to the orthophoto shot by the aircraft is obtained, and the flight altitude, the flight radius, and the circumnavigation center of the aircraft in oblique shooting is determined according to the flight information. For example, the flight altitude when the orthophoto is shot is selected as the flight altitude and the flight radius of the aircraft in oblique shooting, and a coordinate point at a position where the aircraft shot is selected as the circumnavigation center.

Obtaining the flight information corresponding to the orthophoto shot by the aircraft specifically includes obtaining the flight route information corresponding to the orthophoto shot by the aircraft and determining a flight area of the aircraft according to the flight route information. That is, a location area covered by the aircraft is determined by the flight route, and a part of the location area is selected as the flight area. In some embodiments, the flight area may be the largest location area where the aircraft flies.

S103, controlling the flight of the aircraft and orientation of the photographing device according to the flight altitude, the flight radius, and the circumnavigation center to shoot an oblique photo, so as to determine aerial survey parameters according to the orthophoto and the oblique photo.

In some embodiments, based on the flight altitude, flight radius, and circumnavigation center, the aircraft is controlled to fly around the circumnavigation center according to the flight altitude and the flight radius, and the orientation of the photographing device is controlled according to the flight altitude and the flight radius during the flight to shoot the oblique photo. Controlling the orientation of the photographing device may include directly controlling shooting direction of the camera, or adjusting the gimbal to control the shooting direction of the camera.

According to this aerial survey method, after shooting of the orthophoto is completed, shooting of the oblique photo is also completed according to the flight information corresponding to the orthophoto, so as to determine more accurate aerial survey parameters according to the orthophoto and the oblique photo. The aerial survey parameter is, for example, the focal length of the camera, or another parameter. Because the oblique photo is also shot when the orthophoto is shot, the focal length is optimized in a non-linear optimization process of mapping processing, which can better solve problem of focal length ambiguity, and then solve height value ambiguity of the aerial survey in elevation direction, so that accuracy of the orthophoto for mapping is improved.

In some embodiments, controlling the flight of the aircraft and the orientation of the photographing device according to the flight altitude, the flight radius, and the circumnavigation center to shoot the oblique photo includes: determining a circumnavigation route of the aircraft and a shooting inclination angle of the photographing device according to the flight altitude, flight radius, and circumnavigation center; adjusting the photographing device of the aircraft according to the shooting inclination angle and controlling the aircraft to fly according to the circumnavigation route to shoot the oblique photo.

In some embodiments, the circumnavigation route of the aircraft and the shooting inclination angle of the photographing device are first determined according to the flight altitude, flight radius, and circumnavigation center, and then the photographing device of the aircraft is adjusted according to the shooting inclination angle, so that the photographing device can shoot according to the shooting inclination angle when the aircraft is flying according to the circumnavigation route to complete the shooting of the oblique photo. Flying according to the circumnavigation route and shooting according to the determined shooting inclination angle can improve shooting efficiency and data stability of the oblique photo.

In some embodiments, in order to improve accuracy of the aerial survey parameters, specifically, the circumnavigation route of the aircraft in the flight area and the shooting inclination angle of the photographing device are determined according to the flight altitude, flight radius, and circumnavigation center, so that the aircraft can fly according to the circumnavigation route and complete the shooting of the oblique photo with using the shooting inclination angle.

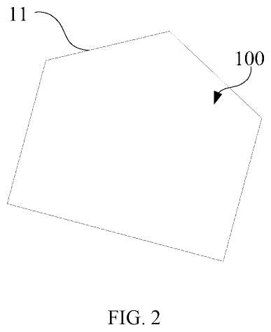

In some embodiments, the circumnavigation route is determined within the flight area of the aircraft, where the flight area is determined according to the flight route. As shown in FIG. 2, the flight route of the aircraft corresponding to the orthophoto is, for example, flight route 11 in FIG. 2, so that flight area 100 can be determined according to the flight route 11. In some other embodiments, a part of the location area defined by the flight route 11 can also be selected as the flight area 100.

In some embodiments, determining the circumnavigation route of the aircraft in the flight area and the shooting inclination angle of the photographing device according to the flight altitude, the flight radius, and the circumnavigation center specifically includes: determining the flight radius according to the flight altitude, and determining the circumnavigation center according to the flight area; calculating the circumnavigation route according to the circumnavigation center and the flight radius; and calculating the shooting inclination angle of the photographing device according to the flight altitude and the flight radius.

In some embodiments, the flight radius is determined according to the flight altitude, for example, the flight altitude is selected as the flight radius. Correspondingly, calculating the shooting inclination angle of the photographing device according to the flight altitude and the flight radius includes: calculating the shooting inclination angle of the photographing device according to the flight altitude and the flight radius based on a trigonometric function relationship, and the shooting inclination angle is obtained as 45°.

A location point in the flight area is selected as the circumnavigation center, a circle or an arc with a preset radian number is made around the circumnavigation center with the determined flight radius, and the circle or the arc with the preset radian number is used as the circumnavigation route. In this disclosure, “radian number” can refer to, e.g., a magnitude of an angle or a span of an arc in terms of radians. The preset radian number can be greater than or equal to π, and the arc with the preset radian number can be, for example, a semicircle, etc.

It should be understood that if the flight altitude is not selected as the flight radius, the shooting inclination angle of the photographing device can be calculated according to the flight altitude and the flight radius based on the trigonometric function relationship.

In some other embodiments, determining the circumnavigation route of the aircraft in the flight area and the shooting inclination angle of the photographing device according to the flight altitude, the flight radius, and the circumnavigation center specifically includes: obtaining the shooting inclination angle of the photographing device, and calculating the flight radius according to the shooting inclination angle and the flight altitude; determining the circumnavigation center according to the flight area, and calculating the circumnavigation route according to the circumnavigation center and the flight radius.

In some embodiments, the shooting inclination angle of the photographing device preset by a user is obtained. For example, the shooting inclination angle set by the user is 45°. In some other embodiments, another angle can also be set, such as 20°, 30°, 60°, etc. Then, the flight radius is calculated according to the shooting inclination angle and flight altitude set by the user using the trigonometric function relationship.

It should be noted that the shooting inclination angle is 45° in some embodiments. According to spatial forward intersection principle, it can be known that the best aerial survey parameters can be obtained when the shooting inclination angle is 45°.

In some embodiments, determining the circumnavigation center according to the flight area specifically includes: determining a circumscribed frame corresponding to the flight area and a center of the circumscribed frame, and using the center of the circumscribed frame as the circumnavigation center.

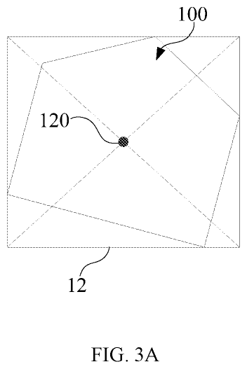

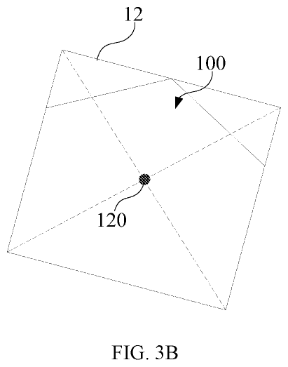

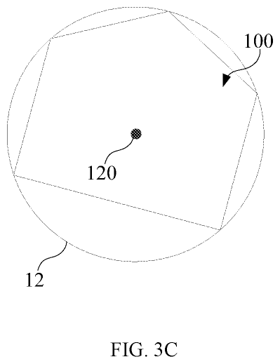

In some embodiments, as shown in FIG. 3A, circumscribed rectangle 12 of the flight area 100 is first determined, and two diagonal lines of the circumscribed rectangle 12 (two dashed lines in FIG. 3A) is connected. An intersection of the two diagonal lines is a center of the circumscribed rectangle 12, and the center of the circumscribed rectangle 12 is used as the circumnavigation center, specifically as circumnavigation center 120 in FIG. 3A.

In some other embodiments, the circumscribed frame may also be a circumscribed square or a circumscribed circle, as shown in FIGS. 3B and 3C, respectively, which can also quickly determine the circumnavigation center 120. When the circumscribed frame is a circumscribed square, the circumnavigation center can also be determined by connecting the diagonal lines; when the circumscribed frame is a circumscribed circle, the circumnavigation center is determined according to a center of the circle.

It can be understood that, in some other embodiments, the circumnavigation center can also be determined through an inscribed polygon or an inscribed circle.

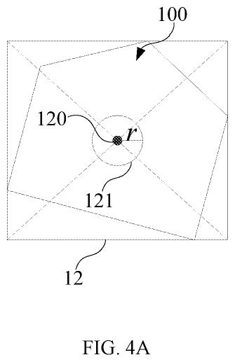

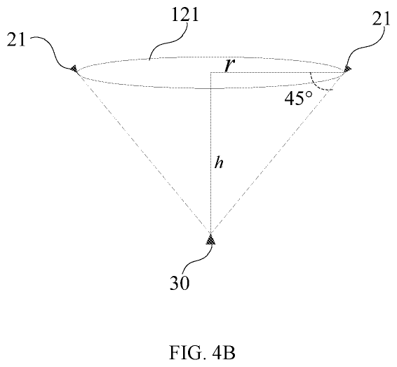

Calculating the circumnavigation route according to the circumnavigation center and the flight radius specifically includes: making a circle with the circumnavigation center and the flight radius. Referring to FIGS. 4A and 4B, in FIG. 4A, the circumnavigation center 120 is used as circle center, and a circle is made using flight radius r as circle radius to obtain circumnavigation route 121. In some embodiments, the flight radius r is equal to flight altitude h, in order to adjust the shooting inclination angle to 45°.

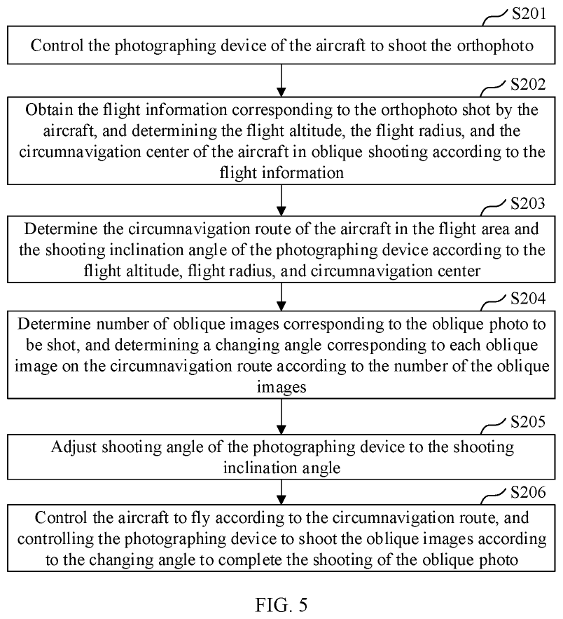

FIG. 5 is a schematic flow chart of another aerial survey method according to an embodiment of the present disclosure. The aerial survey method can be applied to the aircraft, which includes the unmanned aerial vehicle provided with the photographing device.

In some embodiments, as shown in FIG. 5, the aerial survey method includes processes S201-S206.

S201, controlling the photographing device of the aircraft to shoot the orthophoto.

When the aircraft is used to perform aerial survey, the photographing device of the aircraft is controlled to shoot the orthophoto. The photographing device includes the camera mounted at the aircraft, or the camera and the gimbal.

S202, obtaining the flight information corresponding to the orthophoto shot by the aircraft, and determining the flight altitude, the flight radius, and the circumnavigation center of the aircraft in oblique shooting according to the flight information.

After the photographing device of the aircraft is controlled to complete shooting the orthophoto, the flight information corresponding to the orthophoto shot by the aircraft is obtained, and the flight altitude, the flight radius, and the circumnavigation center of the aircraft in oblique shooting is determined according to the flight information.

For example, the obtained flight information includes the flight area and flight altitude corresponding to the orthophoto shot by the aircraft. Specifically, the flight altitude, the flight radius, and the circumnavigation center of the aircraft in oblique shooting can be determined according to the flight area and flight altitude corresponding to the orthophoto.

For example, the flight altitude corresponding to the orthophoto shot by the aircraft is used as the flight altitude and the flight radius of the aircraft in oblique shooting, and a position point within the flight area is selected as the circumnavigation center.

In some embodiments, selecting a position point within the flight area as the circumnavigation center specifically includes: selecting a position point within the flight area as the circumnavigation center according to the flight radius, so that corresponding distances from the circumnavigation center to boundary of the flight area are all greater than the flight radius.

S203, determining the circumnavigation route of the aircraft in the flight area and the shooting inclination angle of the photographing device according to the flight altitude, flight radius, and circumnavigation center.

In some embodiments, the flight radius is determined according to the flight altitude, and the circumnavigation center is determined according to the flight area; the circumnavigation route is calculated according to the circumnavigation center and the flight radius; and the shooting inclination angle of the photographing device is calculated according to the flight altitude and the flight radius.

For example, a location point in the flight area is selected as the circumnavigation center, a circle or an arc with a preset radian number is made around the circumnavigation center with the determined flight radius, and the circle or the arc with the preset radian number is used as the circumnavigation route. The preset radian number is greater than or equal to π.

For example, the flight altitude is selected as the flight radius, and the shooting inclination angle of the photographing device is calculated according to the flight altitude and the flight radius based on the trigonometric function relationship. The shooting inclination angle is obtained as 45°.

S204, determining number of oblique images corresponding to the oblique photo to be shot, and determining a changing angle corresponding to each oblique image on the circumnavigation route according to the number of the oblique images. In this disclosure, a number of images is also referred to as an “image number.”

The number of the oblique images corresponding to the oblique photo to be shot can be set by the user. For example, the number of the oblique images corresponding to the oblique photo to be shot set by the user is obtained, and the changing angle corresponding to each oblique image on the circumnavigation route is determined according to the number of the oblique images.

For example, the circumnavigation route is a circle, and if number of the oblique images is n, then the changing angle corresponding to each oblique image on the circumnavigation route is 2π/n, and the changing angle is expressed in radians.

It should be understood that, in some other embodiments, the changing angle on the circumnavigation route can also be converted into changing distance, that is, arc length is calculated by using central angle, and the arc length is the changing distance.

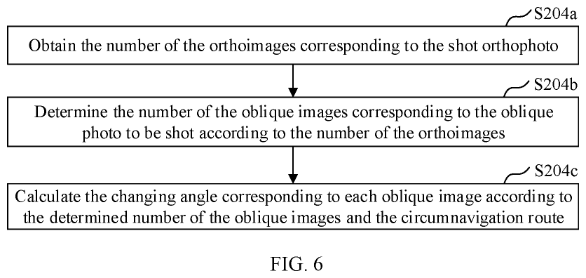

In some embodiments, in order to balance collection efficiency of the oblique photo and the effect of later map-building, and to improve the accuracy of the aerial survey parameters, number of orthoimages corresponding to the shot orthophoto is used to determine the changing angle corresponding to each oblique image on the circumnavigation route. Specifically, as shown in FIG. 6, process S204 includes sub-processes S204a-S204c.

S204a, obtaining the number of the orthoimages corresponding to the shot orthophoto.

Number of all orthoimages corresponding to the shot orthophoto is obtained, or number of the orthoimages corresponding to the orthophoto based on preset interval frames can also be obtained. The preset frame intervals are set according to size of the orthophoto.

S204b, determining the number of the oblique images corresponding to the oblique photo to be shot according to the number of the orthoimages.

In some embodiments, based on a preset correspondence relationship between the number of the orthoimages and the number of the oblique images, the number of the oblique images corresponding to the oblique photo to be shot is calculated according to the obtained number of the orthoimages.

In some embodiments, the preset correspondence relationship between the number of the orthoimages and the number of the oblique images is expressed as:

n=(5%˜10%)*N

n is the number of the oblique images corresponding to the oblique photo to be shot, and N is the number of the orthoimages.

It should be noted that, in some other embodiments, the preset correspondence relationship between the number of the orthoimages and the number of the oblique images may also be expressed in another form, such as adopting another linear function form, with the purpose of establishing a linear relationship between the number of the orthoimages and the number of the oblique images.

In some embodiments, in order to further improve the collection efficiency of the oblique photo and the accuracy of the aerial survey parameters, determining the number of the oblique images corresponding to the oblique photo to be shot according to the number of the orthoimages specifically includes: determining a preset level correspondence relationship between the number of the orthoimages and the number of the oblique images according to a size relationship between the number of the orthoimages and a preset number threshold, where the preset number threshold is configured to determine size of number of the shot orthophoto; determining the number of the oblique images corresponding to the oblique photo to be shot according to the determined level correspondence relationship.

For example, the preset level correspondence relationship between the number of the orthoimages and the number of the oblique images includes a first-level correspondence relationship and a second-level correspondence relationship, where the first-level correspondence relationship is expressed as n=5%*N, and the second-level correspondence relationship is expressed as n=10%*N. In the expressions of the first-level correspondence relationship and the second-level correspondence relationship, n is the number of the oblique images corresponding to the oblique photo to be shot, and N is the number of the orthoimages.

In some embodiments, the size relationship between the number of the orthoimages and the preset number threshold is determined. If the number of the orthoimages is not less than the preset number threshold, the first-level correspondence relationship is determined; if the number of the orthoimages is less than the preset number threshold, the second-level correspondence relationship is determined. The number of the oblique images corresponding to the oblique photo to be shot is determined according to the determined level correspondence relationship. A corresponding number of the oblique images can be collected according to the number of the orthoimages using a preset data threshold, which can improve the collection efficiency and ensure the accuracy of the aerial survey parameters.

It should be noted that, in some other embodiments, more level correspondence relationships can be set referring to a realization principle of the first-level correspondence relationship and the second-level correspondence relationship, which can improve the collection efficiency and ensure the accuracy of the aerial survey parameters.

S204c, calculating the changing angle corresponding to each oblique image according to the determined number of the oblique images and the circumnavigation route.

A radian of the circumnavigation route is determined first, and then the changing angle corresponding to each oblique image on the circumnavigation route is calculated according to the radian number of the circumnavigation route and the number of the oblique images. For example, the radian number of the circumnavigation route is 2π, and the changing angle corresponding to each oblique image is 2π/n.

S205, adjusting shooting angle of the photographing device to the shooting inclination angle.

If the photographing device is the camera, shooting angle of the camera can be directly adjusted to the shooting inclination angle, for example, the shooting angle of the camera is adjusted to 45°. As shown in FIG. 4B specifically, when the aircraft is flying according to the circumnavigation route 121, shooting angles of camera 21 relative to ground target 30 are all 45°. If the photographing device includes the camera and the gimbal, inclination angle of the gimbal can be adjusted to the shooting inclination angle, for example, the inclination angle of the gimbal is adjusted to 45°.

S206, controlling the aircraft to fly according to the circumnavigation route, and controlling the photographing device to shoot the oblique images according to the changing angle to complete the shooting of the oblique photo.

In some embodiments, the aircraft is controlled to fly according to the circumnavigation route, an oblique image is collected at every other changing angle on the circumnavigation route from a starting point, and the shooting of the oblique photo is completed when the aircraft completes the flight according to the circumnavigation route.

According to the aerial survey method described in the above embodiments, the photographing device of the aircraft is controlled to shoot the orthophoto; the flight information corresponding to the orthophoto shot by the aircraft is obtained, and the flight altitude, the flight radius, and the circumnavigation center of the aircraft in oblique shooting is determined according to the flight information; the flight of the aircraft and the orientation of the photographing device are controlled according to the flight altitude, the flight radius, and the circumnavigation center to shoot the oblique photo. Meanwhile, the changing angle is introduced when the oblique photo is shot, and the oblique images are collected according to the changing angle, which ensures symmetry of the oblique images, so that the aerial survey parameters are determined according to the orthophoto and the oblique photo, and accuracy of subsequent mapping is improved.

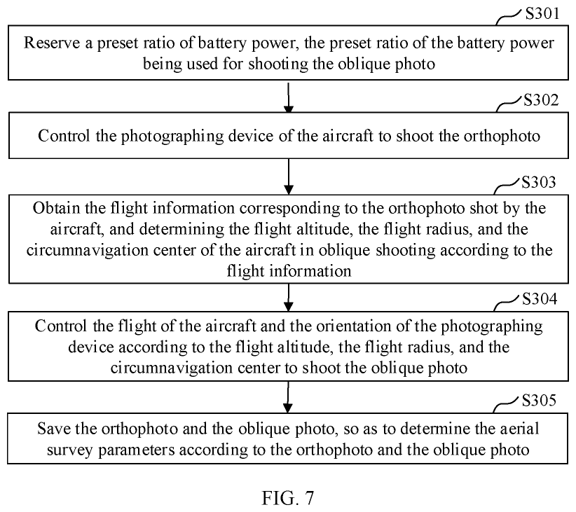

FIG. 7 is a schematic flow chart of another aerial survey method according to an embodiment of the present disclosure. The aerial survey method can be applied to the aircraft, which includes shooting the orthophoto and shooting the oblique photo according to the flight information corresponding to the orthophoto. Therefore, a function option can be added to aircraft application based on the aerial survey method, and the aircraft is controlled to use the aerial survey method to perform the aerial survey when the user selects the function option.

In some embodiments, as shown in FIG. 7, the aerial survey method includes processes S301-S305.

S301, reserving a preset ratio of battery power, the preset ratio of the battery power being used for shooting the oblique photo.

In some embodiments, when the user selects the function option that triggers the aerial survey method, the preset ratio of the battery power is reserved, and the preset ratio of the battery power is used for shooting the oblique photo. For example, 10% of the power is deducted for shooting the oblique photo. In some other embodiments, the preset ratio may also include another value, such as 5%, 15%, or 20%, so as to ensure that the aircraft can complete the aerial survey method.

S302, controlling the photographing device of the aircraft to shoot the orthophoto.

When the aircraft is used to perform the aerial survey, the photographing device of the aircraft is controlled to shoot the orthophoto, and the photographing device includes the camera or the gimbal mounted at the aircraft.

S303, obtaining the flight information corresponding to the orthophoto shot by the aircraft, and determining the flight altitude, the flight radius, and the circumnavigation center of the aircraft in oblique shooting according to the flight information.

After the photographing device of the aircraft is controlled to complete shooting the orthophoto, the flight information corresponding to the orthophoto shot by the aircraft is obtained, and the flight altitude, the flight radius, and the circumnavigation center of the aircraft in oblique shooting is determined according to the flight information. For example, the flight information includes the flight area and flight altitude corresponding to the orthophoto. Specifically, the flight altitude, the flight radius, and the circumnavigation center of the aircraft in oblique shooting are determined according to the flight area and flight altitude corresponding to the orthophoto.

S304, controlling the flight of the aircraft and the orientation of the photographing device according to the flight altitude, the flight radius, and the circumnavigation center to shoot the oblique photo.

In some embodiments, based on the flight altitude, flight radius, and circumnavigation center, the aircraft is controlled to fly around the circumnavigation center according to the flight altitude and the flight radius, and the orientation of the photographing device is controlled according to the flight altitude and the flight radius during the flight to shoot the oblique photo. Controlling the orientation of the photographing device may include directly controlling the shooting direction of the camera, or adjusting the gimbal to control the shooting direction of the camera.

S305, saving the orthophoto and the oblique photo, so as to determine the aerial survey parameters according to the orthophoto and the oblique photo.

After the oblique photo is shot, the orthophoto and oblique photo are correspondingly stored in the aircraft, so that the aircraft can determine the aerial survey parameters according to the orthophoto and the oblique photo. The aerial survey parameter is, for example, the focal length, and the focal length ambiguity can be eliminated.

According to the aerial survey method described in the above embodiments, the preset ratio of the battery power is reserved for shooting the oblique photo; the flight information corresponding to the orthophoto shot by the aircraft is obtained, and the flight altitude, the flight radius, and the circumnavigation center of the aircraft in oblique shooting are determined according to the flight information; the flight of the aircraft and the orientation of the photographing device are controlled according to the flight altitude, the flight radius, and the circumnavigation center to shoot the oblique photo; and the orthophoto and the oblique photo are saved. The aerial survey method can ensure that after the orthophoto is shot, corresponding power is reserved to shoot the oblique photo, so that the aerial survey parameters can be determined according to the orthophoto and the oblique photo, which can ensure mapping accuracy.

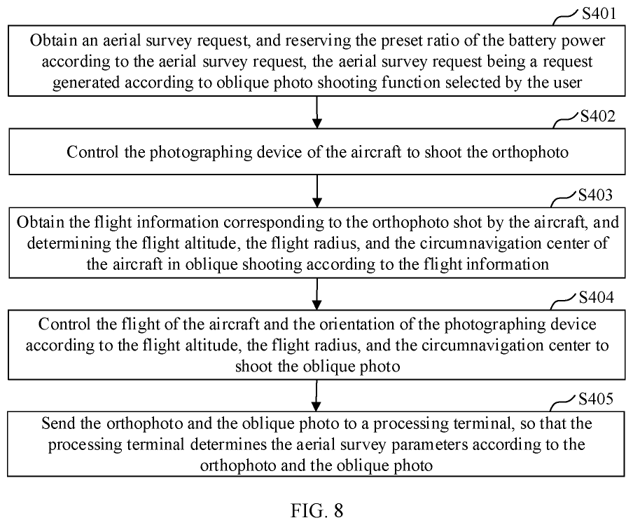

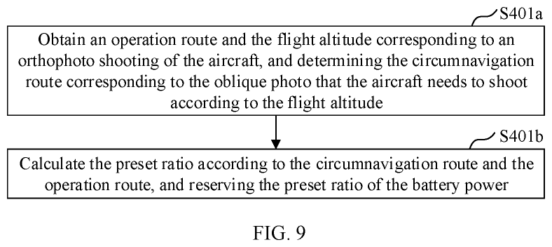

FIG. 8 is a schematic flow chart of another aerial survey method according to an embodiment of the present disclosure. The aerial survey method can be applied to a flight system, which includes the aircraft and a control terminal for controlling the flight of the aircraft. The aircraft includes the unmanned aerial vehicle provided with the photographing device, and the control terminal includes a remote control and an intelligent terminal.

In some embodiments, as shown in FIG. 8, the aerial survey method includes processes S401-S405.

S401, obtaining an aerial survey request, and reserving the preset ratio of the battery power according to the aerial survey request, the aerial survey request being a request generated according to oblique photo shooting function selected by the user.

In some embodiments, the aerial survey request sent by the control terminal is received, and the aerial survey request is a request generated by the control terminal according to the oblique photo shooting function selected by the user. The preset ratio of the battery power is reserved according to the aerial survey request, and the preset ratio of the battery power is used for shooting the oblique photo.

In some embodiments, reserving the preset ratio of the battery power specifically includes the following processes.

S401a, obtaining an operation route and the flight altitude corresponding to an orthophoto shooting of the aircraft, and determining the circumnavigation route corresponding to the oblique photo that the aircraft needs to shoot according to the flight altitude.

Before the aircraft is ready to perform the orthophoto shooting, the user will set the corresponding operation route and the corresponding flight altitude, i.e., plan an aerial survey route and aerial survey flight altitude of the aircraft. The circumnavigation route corresponding to the oblique photo that the aircraft needs to shoot is determined according to the flight altitude, and specifically, the flight altitude can be used as the flight radius to obtain the circumnavigation route. It should be noted that the circumnavigation route is obtained through pre-calculation according to the flight altitude set by the user.

S401b, calculating the preset ratio according to the circumnavigation route and the operation route, and reserving the preset ratio of the battery power.

In some embodiments, a pre-calculated circumnavigation route and operation route are calculated in ratio, and an obtained ratio relationship is the preset ratio. The preset ratio of the battery power is reserved for shooting the oblique photo, which can ensure that sufficient and accurate battery power is reserved to complete the shooting of the oblique photo.

S402, controlling the photographing device of the aircraft to shoot the orthophoto.

The photographing device of the aircraft is controlled to shoot the orthophoto. The aircraft can fly according to the pre-set flight parameters during the aerial survey shooting, and the photographing device is controlled to shoot the orthophoto during the flight of the aircraft. The flight parameters include, but are not limited to, the preset flight route, aerial survey altitude, and flight speed. The aerial survey altitude is the flight altitude set during the aerial survey of the aircraft.

S403, obtaining the flight information corresponding to the orthophoto shot by the aircraft, and determining the flight altitude, the flight radius, and the circumnavigation center of the aircraft in oblique shooting according to the flight information.

After the photographing device of the aircraft is controlled to complete shooting the orthophoto, the flight information corresponding to the orthophoto shot by the aircraft is obtained, and the flight altitude, the flight radius, and the circumnavigation center of the aircraft in oblique shooting is determined according to the flight information. For example, the flight altitude when the orthophoto is shot is selected as the flight altitude and the flight radius of the aircraft in oblique shooting, and a coordinate point at the position where the aircraft shot is selected as the circumnavigation center.

Obtaining the flight information corresponding to the orthophoto shot by the aircraft specifically includes obtaining the flight route information corresponding to the orthophoto shot by the aircraft and determining the flight area of the aircraft according to the flight route information. That is, the location area covered by the aircraft is determined by the flight route, and a part of the location area is selected as the flight area. In some embodiments, the flight area may be the largest location area where the aircraft flies.

S404, controlling the flight of the aircraft and the orientation of the photographing device according to the flight altitude, the flight radius, and the circumnavigation center to shoot the oblique photo.

In some embodiments, the circumnavigation route of the aircraft and the shooting inclination angle of the photographing device are determined according to the flight altitude, flight radius, and circumnavigation center; the photographing device of the aircraft is adjusted according to the shooting inclination angle and the aircraft is controlled to fly according to the circumnavigation route to shoot the oblique photo.

In some embodiments, the circumnavigation route of the aircraft in the flight area and the shooting inclination angle of the photographing device are determined according to the flight altitude, flight radius, and circumnavigation center.

For example, the flight radius is determined according to the flight altitude, and the circumnavigation center is determined according to the flight area; the circumnavigation route is calculated according to the circumnavigation center and the flight radius; and the shooting inclination angle of the photographing device is calculated according to the flight altitude and the flight radius.

As another example, the shooting inclination angle of the photographing device is obtained, and the flight radius is calculated according to the shooting inclination angle and the flight altitude; the circumnavigation center is determined according to the flight area, and the circumnavigation route is calculated according to the circumnavigation center and the flight radius.

S405, sending the orthophoto and the oblique photo to a processing terminal, so that the processing terminal determines the aerial survey parameters according to the orthophoto and the oblique photo.

The processing terminal includes a terminal device or a server, and the terminal device is, for example, a computer. The processing terminal is provided with mapping processing software, and the mapping processing software is configured to determine the aerial survey parameters according to the orthophoto and the oblique photo, so that the accuracy of the aerial survey parameters is improved, and mapping accuracy of the mapping processing software can also be ensured.

According to the aerial survey method described in the above embodiments, when the aerial survey request is received, the preset ratio of the battery power is calculated and reserved for shooting the oblique photo; the flight information corresponding to the orthophoto shot by the aircraft is obtained, and the flight altitude, the flight radius, and the circumnavigation center of the aircraft in oblique shooting are determined according to the flight information; the flight of the aircraft and the orientation of the photographing device are controlled according to the flight altitude, the flight radius, and the circumnavigation center to shoot the oblique photo; and the orthophoto and the oblique photo are saved. The aerial survey method can ensure that the oblique photo can also be shot when the orthophoto is shot, so that the aerial survey parameters can be determined according to the orthophoto and the oblique photo, which can ensure the mapping accuracy.

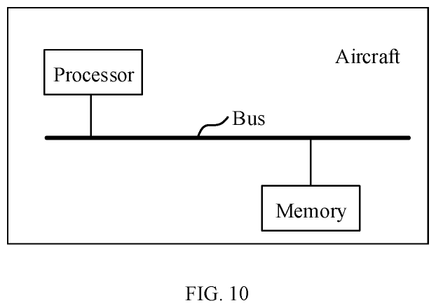

FIG. 10 is a schematic structural block diagram of the aircraft according to an embodiment of the present disclosure. The aircraft includes a body, the photographing device, a processor, and a memory. The processor and the memory are connected through a bus, such as an I2C (Inter-integrated Circuit) bus.

In some embodiments, the photographing device is connected to the body to shoot an image, and the photographing device includes the camera, or the camera and the gimbal.

In some embodiments, the processor may be a micro-controller unit (MCU), a central processing unit (CPU), a digital signal processor (DSP), etc.

In some embodiments, the memory may be a flash chip, a read-only memory (ROM) disk, an optical disk, a U disk, a mobile hard disk, etc.

The processor is configured to run a computer program stored in the memory, and implement the following processes when executing the computer program: controlling the photographing device of the aircraft to shoot the orthophoto; obtaining the flight information corresponding to the orthophoto shot by the aircraft, and determining the flight altitude, the flight radius, and the circumnavigation center of the aircraft in oblique shooting according to the flight information; and controlling the flight of the aircraft and the orientation of the photographing device according to the flight altitude, the flight radius, and the circumnavigation center to shoot the oblique photo, so as to determine the aerial survey parameters according to the orthophoto and the oblique photo.

In some embodiments, when implementing controlling the flight of the aircraft and the orientation of the photographing device according to the flight altitude, the flight radius, and the circumnavigation center to shoot the oblique photo, the processor implements the following processes: determining the circumnavigation route of the aircraft and the shooting inclination angle of the photographing device according to the flight altitude, flight radius, and circumnavigation center; adjusting the photographing device of the aircraft according to the shooting inclination angle and controlling the aircraft to fly according to the circumnavigation route to shoot the oblique photo.

In some embodiments, the flight information includes the flight area. When implementing determining the circumnavigation route of the aircraft and the shooting inclination angle of the photographing device according to the flight altitude, flight radius, and circumnavigation center, the processor implements the following processes: determining the circumnavigation route of the aircraft in the flight area and the shooting inclination angle of the photographing device according to the flight altitude, flight radius, and circumnavigation center.

In some embodiments, when implementing determining the circumnavigation route of the aircraft in the flight area and the shooting inclination angle of the photographing device according to the flight altitude, flight radius, and circumnavigation center, the processor implements the following processes: determining the flight radius according to the flight altitude, and determining the circumnavigation center according to the flight area; calculating the circumnavigation route according to the circumnavigation center and the flight radius; and calculating the shooting inclination angle of the photographing device according to the flight altitude and the flight radius.

In some embodiments, when implementing determining the circumnavigation route of the aircraft in the flight area and the shooting inclination angle of the photographing device according to the flight altitude, flight radius, and circumnavigation center, the processor implements the following processes: obtaining the shooting inclination angle of the photographing device, and calculating the flight radius according to the shooting inclination angle and the flight altitude; determining the circumnavigation center according to the flight area, and calculating the circumnavigation route according to the circumnavigation center and the flight radius.

In some embodiments, when implementing calculating the circumnavigation route according to the circumnavigation center and the flight radius, the processor implements the following processes: making a circle or an arc with a preset radian number with the circumnavigation center and the flight radius to determine the circumnavigation route. The preset radian number is greater than or equal to π.

In some embodiments, when implementing determining the circumnavigation center according to the flight area, the processor implements the following processes: determining the circumscribed frame corresponding to the flight area and the center of the circumscribed frame, and using the center of the circumscribed frame as the circumnavigation center.

In some embodiments, the circumscribed frame includes a circumscribed rectangle, a circumscribed square, or a circumscribed circle.

In some embodiments, when implementing determining the flight radius according to the flight altitude, the processor implements the following processes: selecting the flight altitude as the flight radius.

In some embodiments, when implementing calculating the shooting inclination angle of the photographing device according to the flight altitude and the flight radius, the processor implements the following processes: calculating the shooting inclination angle of the photographing device according to the flight altitude and the flight radius based on the trigonometric function relationship. The shooting inclination angle is obtained as 45°.

In some embodiments, when implementing obtaining the shooting inclination angle of the photographing device, the processor implements the following processes: obtaining an inclination angle of the photographing device preset by the user as the shooting inclination angle.

In some embodiments, the inclination angle of the photographing device preset by the user is 45°.

In some embodiments, before implementing adjusting the photographing device of the aircraft according to the shooting inclination angle and controlling the aircraft to fly according to the circumnavigation route to shoot the oblique photo, the processor implements the following processes: determining the number of the oblique images corresponding to the oblique photo to be shot, and determining the changing angle corresponding to each oblique image on the circumnavigation route according to the number of the oblique images. Correspondingly, when implementing adjusting the photographing device of the aircraft according to the shooting inclination angle and controlling the aircraft to fly according to the circumnavigation route to shoot the oblique photo, the processor implements the following processes: adjusting the shooting angle of the photographing device to the shooting inclination angle; controlling the aircraft to fly according to the circumnavigation route, and controlling the photographing device to shoot the oblique images according to the changing angle to complete the shooting of the oblique photo.

In some embodiments, when implementing determining the number of the oblique images corresponding to the oblique photo to be shot, and determining the changing angle corresponding to each oblique image on the circumnavigation route according to the number of the oblique images, the processor implements the following processes: obtaining the number of the orthoimages corresponding to the shot orthophoto; determining the number of the oblique images corresponding to the oblique photo to be shot according to the number of the orthoimages; and calculating the changing angle corresponding to each oblique image according to the determined number of the oblique images and the circumnavigation route.

In some embodiments, when implementing determining the number of the oblique images corresponding to the oblique photo to be shot according to the number of the orthoimages, the processor implements the following processes: based on the preset correspondence relationship between the number of the orthoimages and the number of the oblique images, calculating the number of the oblique images corresponding to the oblique photo to be shot according to the obtained number of the orthoimages.

In some embodiments, the preset correspondence relationship between the number of the orthoimages and the number of the oblique images is expressed as:

n=(5%˜10%)*N

n is the number of the oblique images corresponding to the oblique photo to be shot, and N is the number of the orthoimages.

In some embodiments, when implementing determining the number of the oblique images corresponding to the oblique photo to be shot according to the number of the orthoimages, the processor implements the following processes: determining the preset level correspondence relationship between the number of the orthoimages and the number of the oblique images according to the size relationship between the number of the orthoimages and the preset number threshold, where the preset number threshold is configured to determine the size of number of the shot orthophoto; determining the number of the oblique images corresponding to the oblique photo to be shot according to the determined level correspondence relationship.

In some embodiments, when implementing obtaining the flight information corresponding to the orthophoto shot by the aircraft, the processor implements the following processes: obtaining the flight route information corresponding to the orthophoto shot by the aircraft, and determining the flight area of the aircraft according to the flight route information.

In some embodiments, before implementing controlling the photographing device of the aircraft to shoot the orthophoto, the processor implements the following processes: reserving the preset ratio of battery power, the preset ratio of the battery power being used for shooting the oblique photo.

In some embodiments, when implementing reserving the preset ratio of battery power, the processor implements the following processes: obtaining the operation route and the flight altitude corresponding to the orthophoto shooting of the aircraft, and determining the circumnavigation route corresponding to the oblique photo that the aircraft needs to shoot according to the flight altitude; calculating the preset ratio according to the circumnavigation route and the operation route, and reserving the preset ratio of the battery power.

In some embodiments, the preset ratio is configured to implement 5%, 10%, or 20%.

In some embodiments, before implementing reserving the preset ratio of battery power, the processor implements the following processes: obtaining the aerial survey request, and reserving the preset ratio of the battery power according to the aerial survey request, the aerial survey request being the request generated according to the oblique photo shooting function selected by the user.

In some embodiments, when implementing obtaining the aerial survey request, the processor implements the following processes: receiving the aerial survey request sent by the control terminal, the aerial survey request being the request generated by the control terminal according to the oblique photo shooting function selected by the user.

In some embodiments, after implementing controlling the flight of the aircraft and the orientation of the photographing device according to the flight altitude, the flight radius, and the circumnavigation center to shoot the oblique photo, the processor implements the following processes: saving the orthophoto and the oblique photo.

In some embodiments, the processor is also configured to implement: sending the orthophoto and the oblique photo to the processing terminal, so that the processing terminal determines the aerial survey parameters according to the orthophoto and the oblique photo.

The present disclosure also provides a computer readable storage medium which stores a computer program. The computer program includes program instructions, and the processor executes the program instructions to implement the processes of the aerial survey method provided in the above embodiments.

The computer readable storage medium may be an internal storage unit of the aircraft described in any of the foregoing embodiments, such as a hard disk or a memory of the aircraft. The computer readable storage medium may also be an external storage device of the aircraft, such as a plug-in hard disk, a smart medio card (SMC), a secure digital (SD) card, a flash card, etc. equipped at the aircraft.

The above are only some specific embodiments of the present disclosure, but the protection scope of the present disclosure is not limited hereto. Any person skilled in the art can easily conceive various equivalent modifications or substitutions within the technical scope disclosed in the present disclosure, and these modifications or substitutions should be within the protection scope of the present disclosure. The protection scope of the present disclosure should be subject to the protection scope of the claims.

What is claimed is:

1. An aerial survey method comprising:
controlling a photographing device of an aircraft to shoot an orthophoto;
obtaining flight information corresponding to the orthophoto;
determining a flight altitude, a flight radius, and a circumnavigation center of the aircraft in oblique shooting according to the flight information; and
controlling flight of the aircraft and an orientation of the photographing device according to the flight altitude, the flight radius, and the circumnavigation center to shoot an oblique photo.

2. The aerial survey method of claim 1, wherein controlling the flight of the aircraft and the orientation of the photographing device according to the flight altitude, the flight radius, and circumnavigation center to shoot the oblique photo includes:
determining a circumnavigation route of the aircraft and a shooting inclination angle of the photographing device according to the flight altitude, the flight radius, and the circumnavigation center; and
adjusting the photographing device according to the shooting inclination angle and controlling the aircraft to fly according to the circumnavigation route to shoot the oblique photo.

3. The aerial survey method of claim 2, wherein:
the flight information includes a flight area; and
determining the circumnavigation route of the aircraft and the shooting inclination angle of the photographing device according to the flight altitude, the flight radius, and the circumnavigation center includes determining the circumnavigation route of the aircraft in the flight area and the shooting inclination angle of the photographing device according to the flight altitude, the flight radius, and the circumnavigation center.

4. The aerial survey method of claim 3, wherein determining the circumnavigation route of the aircraft in the flight area and the shooting inclination angle of the photographing device according to the flight altitude, the flight radius, and the circumnavigation center includes:
determining the flight radius according to the flight altitude;
determining the circumnavigation center according to the flight area;
calculating the circumnavigation route according to the circumnavigation center and the flight radius; and
calculating the shooting inclination angle of the photographing device according to the flight altitude and the flight radius.

5. The aerial survey method of claim 4, wherein determining the flight radius according to the flight altitude includes selecting the flight altitude as the flight radius.

6. The aerial survey method of claim 5, wherein calculating the shooting inclination angle includes calculating the shooting inclination angle to be 45° according to the flight altitude and the flight radius based on a trigonometric function relationship.

7. The aerial survey method of claim 3, wherein determining the circumnavigation route of the aircraft in the flight area and the shooting inclination angle of the photographing device according to the flight altitude, the flight radius, and the circumnavigation center includes:
obtaining the shooting inclination angle of the photographing device;
calculating the flight radius according to the shooting inclination angle and the flight altitude;
determining the circumnavigation center according to the flight area; and
calculating the circumnavigation route according to the circumnavigation center and the flight radius.

8. The aerial survey method of claim 7, wherein obtaining the shooting inclination angle includes obtaining an inclination angle of the photographing device preset by a user as the shooting inclination angle.

9. The aerial survey method of claim 8, wherein the inclination angle is 45°.

10. The aerial survey method of claim 3, wherein determining the circumnavigation route of the aircraft includes calculating the circumnavigation route according to the circumnavigation center and the flight radius, including determining the circumnavigation route to be a circle or an arc with a preset radian number, the circle or the arc having the circumnavigation center as a center and the flight radius as a radius, and the preset radian number being greater than or equal to π.

11. The aerial survey method of claim 3, wherein calculating the circumnavigation route includes determining the circumnavigation center according to the flight area, including determining a circumscribed frame corresponding to the flight area and a center of the circumscribed frame, and using the center of the circumscribed frame as the circumnavigation center.

12. The aerial survey method of claim 11, wherein the circumscribed frame includes a circumscribed rectangle, a circumscribed square, or a circumscribed circle.

13. The aerial survey method of claim 3, further comprising, before adjusting the photographing device of the aircraft according to the shooting inclination angle and controlling the aircraft to fly according to the circumnavigation route to shoot the oblique photo:
determining a number of oblique images corresponding to the oblique photo to be shot and determining a changing angle corresponding to each of the oblique images on the circumnavigation route according to the number of the oblique images;
wherein adjusting the photographing device according to the shooting inclination angle and controlling the aircraft to fly according to the circumnavigation route to shoot the oblique photo includes:
adjusting a shooting angle of the photographing device to the shooting inclination angle; and
controlling the aircraft to fly according to the circumnavigation route and controlling the photographing device to shoot the oblique images according to the changing angles to complete shooting of the oblique photo.

14. The aerial survey method of claim 13, wherein determining the number of the oblique images corresponding to the oblique photo to be shot and determining the changing angle corresponding to each of the oblique images on the circumnavigation route according to the number of the oblique images includes:
obtaining a number of orthoimages corresponding to the shot orthophoto;
determining the number of the oblique images corresponding to the oblique photo to be shot according to the number of the orthoimages; and
calculating the changing angle corresponding to each of the oblique images according to the determined number of the oblique images and the circumnavigation route.

15. The aerial survey method of claim 1, further comprising, before controlling the photographing device to shoot the orthophoto:
reserving a preset ratio of battery power for using in shooting the oblique photo.

16. The aerial survey method of claim 15, wherein reserving the preset ratio of battery power includes:
obtaining an operation route and the flight altitude corresponding to orthophoto shooting by the aircraft;
determining the circumnavigation route corresponding to the oblique photo that the aircraft needs to shoot according to the flight altitude; and
calculating the preset ratio according to the circumnavigation route and the operation route.

17. The aerial survey method of claim 15, further comprising, before reserving the preset ratio of battery power:
obtaining an aerial survey request, the aerial survey request being a request generated according to an oblique photo shooting function selected by the user;
wherein reserving the preset ratio of the battery power includes reserving the preset ratio of the battery power according to the aerial survey request.

18. The aerial survey method of claim 17, wherein obtaining the aerial survey request includes receiving the aerial survey request sent by a control terminal, the aerial survey request being a request generated by the control terminal according to the oblique photo shooting function selected by the user.

19. The aerial survey method of claim 1, further comprising, after controlling the flight of the aircraft and the orientation of the photographing device according to the flight altitude, the flight radius, and the circumnavigation center to shoot the oblique photo:
saving the orthophoto and the oblique photo.

20. The aerial survey method of claim 1, further comprising:
sending the orthophoto and the oblique photo to a processing terminal.
